(19) United States
(12) Patent Application Publication
(10) Pub. No.: US 2026/0126356 A1
(43) Pub. Date: May 7, 2026

(54) SELECTIVE LIQUID TRANSPORT SYSTEM AND PROCESS

(71) Applicant: THE BOARD OF REGENTS FOR THE OKLAHOMA AGRICULTURAL AND MECHANICAL COLLEGES, Stillwater, OK (US)

(72) Inventors: Yu Mao, Stillwater, OK (US); Mengfan Zhu, Stillwater, OK (US)

(73) Assignee: THE BOARD OF REGENTS FOR THE OKLAHOMA AGRICULTURAL AND MECHANICAL COLLEGES, Stillwater, OK (US)

(21) Appl. No.: 18/704,235

(22) PCT Filed: Nov. 3, 2022
(86) PCT No.: PCT/US2022/048772

§ 371 Date: Apr. 24, 2024

Related U.S. Application Data
(60) Provisional application No. 63/276,241, filed on Nov. 5, 2021.

(51) Int. Cl. G01N 1/40; B01D 17/04; B05D 1/00; G01N 21/3577

(52) U.S. Cl. CPC G01N 1/4055; B01D 17/045; G01N 21/3577; B05D 1/60

(57) ABSTRACT

A methods and systems for separating and analyzing liquid samples wherein a liquid mixture having at least one transport liquid and at least one non-transport liquid is applied to a selective liquid-transport surface. The selective liquid-transport surface is on a substrate and defined by a liquid-repellant background surface on the substrate. The selective liquid-transport area is coated with a substance having a higher affinity with the transport liquid than the non-transport liquid. Additionally, there are methods of preparing the systems for use in separation and analyzing liquid samples.

### CROSS-REFERENCE TO RELATED APPLICATION

This application claims the benefit of U.S. Provisional Application 63/276,241 filed Nov. 5, 2021, which is hereby incorporated by reference.

### FIELD

The present invention relates generally to systems and methods to separate two immiscible phases of microliter droplets using open surfaces, such as, for example, may be used for diagnostics where processing of the samples involves liquid-liquid phase separation.

### BACKGROUND

Miniature, cost-effective devices for sample separation have long been desired for medical diagnostics as well as analysis in areas such as process control and environmental monitoring. Traditional sample separation methods such as centrifugation, solvent extraction, and liquid-liquid phase separation require complex instrumentation and processing.

Such traditional separation methods inflate the cost of diagnostics. Accordingly, cost-effective methods involving smaller samples are desirable.

### SUMMARY

The methods, systems and apparatuses herein cover the use of a fast, disposable, inexpensive way to prepare a sample which requires separation from a first liquid. The sample may be a second liquid. Typically, the first liquid and second liquid will be mixed, combined or blended but will be immiscible. Alternatively, the sample may be dissolved, suspended or mixed in the first liquid and the second liquid. Generally, in this disclosure the first liquid will be referred to as the non-transport liquid and the second liquid will be referred to as the transport liquid.

For example, the system or apparatus can be a selective liquid-transport device for separating a liquid mixture having at least one transport liquid and at least one non-transport liquid. The selective liquid-transport device comprises a substrate. Defined on the substrate is a transport surface having a mixing area (also called the liquid-liquid mixture introduction area), a transport-liquid track, and a transport-liquid receiving area. Additionally, the device comprises a liquid-repellant background surface defined on the substrate. Each of the mixing area, the transport-liquid track, and the transport-liquid receiving area are coated with a substance having a higher affinity with the transport liquid than the non-transport liquid. The liquid-repellant background area is coated with an omniphobic substance having a low affinity with both the transport liquid and the non-transport liquid.

The selective liquid-transport device has a length and a width which are longer and wider than the transport surface. The mixing area has a width of wₘ and a length of lₘ (although in some cases the mixing area can be round with a radius of rₘ, or oval), the transport-liquid track has a length of l and a width of w, and the transport-liquid receiving area has a width of wᵣ and a length of lᵣ (although in some cases the receiving area can be round with a radius of rᵣ, or oval). Additionally, there can be multiple transport surfaces defined on the substrate.

For example, a method under this disclosure can be a method for producing a selective liquid-transport surface comprising a transport surface having a mixing area, a liquid-transport track, and a transport-liquid receiving area, the method comprising:
a. selecting a contiguous geometric shape for a mixing area, a transport-liquid track communicated with the mixing area, and a transport-liquid receiving area communicated with the transport-liquid track;
b. cutting a microcontact polydimethylsiloxane (PDMS) stamp in the geometric shape of the mixing area, transport-liquid track and transport-liquid receiving area;
c. placing the cut PDMS stamp into tight contact with a substrate;
d. forming an adsorbed siloxane surface on the substrate matching the contiguous geometric shape with the PDMS stamp;
e. creating a liquid-repellant background area on the substrate surface; and
f. removing the PDMS stamp from the substrate so as to expose the adsorbed siloxane surface having the contiguous shape of the mixing area, the transport-liquid track, and the transport-liquid receiving area. For example, the substrate is comprised of at least one of silicon, glass, metal, plastic, or paper.

In the method, the creating step can comprise depositing an omniphobic substance onto the portion of the substrate surface that is not in tight contact with the PDMS stamp. The omniphobic substance can be deposited onto the substrate surface by vapor deposition. For example, the omniphobic substance can be poly(1H,1H,2H,2H-heptadecafluorodecyl acrylate).

In the method, the vapor deposition can occur by:
i. vacuuming an initiated chemical vapor deposition reactor to a first predetermined pressure;
ii. vaporizing a monomeric 1H,1H,2H,2H-heptadecafluorodecyl acrylate and an initiator tert-butyl peroxide at first and second temperatures respectively;
iii. injecting the vaporized 1H,1H,2H,2H-heptadecafluorodecyl acrylate and tert-butyl peroxide into the reactor at first and second flow rates respectively;
iv. controlling the pressure within the reactor at a second predetermined pressure;
v. heating the filament of the initiated chemical vapor deposition to an elevated temperature above the first temperature;
vi. cooling the substrate of the initiated chemical vapor deposition reactor to maintain a cooled temperature below the elevated temperature;
vii. monitoring the thickness of the deposited polymer films; and
viii. stopping the initiated chemical vapor deposition process when the deposited polymer reaches a desired thickness.

For example, in the vapor deposition, the first predetermined pressure can be about 0.01 Torr; the first and second temperatures can be about 80 degrees Celsius and about 25 degrees Celsius, respectively; the first and second flow rates can be about 0.4 sccm and about 0.1 sccm, respectively; the second predetermined pressure can be about 0.15 Torr; the elevated temperature can be about 200 degrees Celsius; the cooled temperature below the elevated temperature can be about 40 degrees Celsius; and the desired thickness can be 100 nm.

For example, another method under this disclosure can be a method for separating and analyzing liquid samples. The method comprising:
obtaining a liquid mixture having at least one transport liquid and at least one non-transport liquid;
   a. placing a droplet of the liquid mixture onto a mixing area of a selective liquid-transport surface;
   b. allowing a sufficient amount of time for the transport liquid to transport across a transport-liquid track and into a transport-liquid receiving area of the selective liquid-transport surface;
   c. collecting the transport liquid from the transport-liquid receiving area; and
   d. analyzing the transport liquid.

In some embodiments, the method can include analyzing the collected transport liquid by infra-red spectroscopy.

### BRIEF DESCRIPTION OF THE DRAWINGS

The drawings include in this disclosure illustrate certain aspects of the embodiments described herein. However, the drawings should not be viewed as exclusive embodiments. The subject matter disclosed herein is capable of considerable modifications, alterations, combinations, and equivalents in form and function, as well be evident to those skilled in the art with the benefit of this disclosure. Additionally, the drawings are not to scale.

FIG. 1 is a schematic illustration of a selective liquid transport device in accordance with an embodiment of this disclosure.

FIG. 2 is a schematic illustration of another embodiment of a selective liquid transport in accordance with this disclosure.

FIG. 3 is a schematic illustration of the preparation of a selective liquid transport device in accordance with an embodiment of this disclosure.

FIG. 4 is a schematic illustration of the preparation of a selective liquid transport device in accordance with another embodiment of this disclosure

FIG. 5 is an illustration of the movement of transport fluid on various selective liquid transport devices as described in the Examples.

FIG. 6 is an illustration of the movement of transport fluid on a selective liquid transport device as described in the Examples.

FIG. 7 is a schematic illustration of cholesterol's movement with a hexane transport fluid as described in the Examples.

FIG. 8 is an illustration of the results to the separation of cholesterol and a hexane transport fluid from water as described in the Examples.

FIG. 9 demonstrates the separation of decane and water on surfaces with different combinations of γ1 and γ2.

### DETAILED DESCRIPTION

The present disclosure may be understood more readily by reference to this detailed description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures and components have not been described in detail so as not to obscure the related relevant feature being described. Also, the description is not to be considered as limiting the scope of the embodiments described herein.

This disclosure describes methods and systems to separate liquids from microliter droplets using selective liquid transport on open substrates. This separation technique offers a simple, low-cost solution to separate analytes for analytic assays. The self-driven liquid transport is based on spatially selective affinity on an open substrate surface. Different from traditional microfluidic devices, the liquid transport is spontaneous without microchannels, pumps, valves, or other energy input.

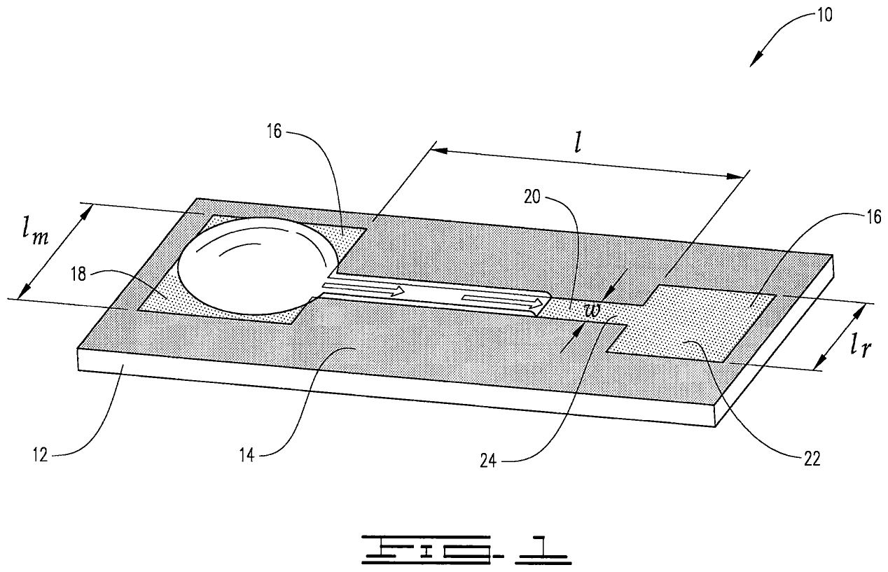

Referring to FIG. 1, a design of the selective liquid transport device 10 is illustrated. Selective liquid-transport device 10 is configured to be used for separating a liquid mixture having at least one transport liquid and at least one non-transport liquid. Selective liquid-transport device 10 comprises a substrate 12. For example, the substrate can be comprised of at least one of silicon, glass, metal, plastic, or paper.

Substrate 12 has a liquid-repellant background surface 14 on the substrate. The liquid-repellant background surface 14 defines at least one transport-surface area 16. The transport-surface area 16 can advantageously be open to the surrounding environment without adversely affecting the operation of the device.

As can be seen from FIG. 1, transport-surface area 16 can have a liquid-mixture introduction area 18, a transport-liquid track 20, and a transport-liquid receiving area 22. For example, the liquid transport track 20 can be a rectangular track having a length of l and a width of w. Length l generally is at least about 2, 3, 4 times the width w, and generally will be no more than about 30, 25, 20, 15 or 10 times the width w. Generally, the width w of the track will be at least about 1.0 mm, at least about 1.2 mm or at least about 1.5 mm and will typically be about 4 mm or less, or about 3 mm or less. The liquid-mixture introduction area 18 and transport-liquid receiving area 22 may be any suitable shape, such as round, square, rectangular, oval, etc. As illustrated, liquid-mixture introduction area 18 is a square shape with side length of lₘ, and transport-liquid receiving area 22 is a square shape with side length of lᵣ. Generally, lₘ and lᵣ can be at least about 3 mm, at least about 4 mm or at least about 5 mm and can generally be about 10 mm or less.

As used herein “transport liquid” and “non-transport liquid” refer to two liquids with different wettability characteristics and/or solubility characteristics. Wetting and wettability involve the contact between a liquid and a solid surface, resulting from the intermolecular interactions when the two are brought together. The amount of wetting depends on the energies (or surface tensions) of the interfaces involved such that the total energy is minimized. One measurement of the degree of wetting is the contact angle, the angle at which the liquid-vapor interface meets the solid-liquid interface. If the wetting is very favorable, the contact angle will be low, and the fluid will spread to cover or “wet” a larger area of the solid surface. If the wetting is unfavorable, the contact angle will be high, and the fluid will form a compact, self-contained droplet on the solid surface. For example, if the contact angle of water on a surface is low, the surface may be said to be “water-wetted” or “water-wettable,” whereas if the contact angle of an oil droplet on a surface is low, the surface may be said to be “oil-wetted” or “oil-wettable.”

As used herein, a water-wet surface has a contact angle for water between 0 to 90 degrees. A surface having a contact angle at or above ninety degrees for water is described as non-water-wet. Similarly, an oil-wet surface has a contact angle for oil between 0 to 90 degrees. A surface having a contact angle at or above ninety degrees for oil is described as non-oil wet.

Under this disclosure, the transport liquids should have a different wettability than the non-transport liquid with respect to transport surface area 16. That is the surface 24 of transport surface area 16 will be wettable with respect to the transport liquid and non-wettable with respect to the non-transport liquid. For example, the transport liquid can have a contact angle of 0 to 90 degrees with surface 24, while the non-transport liquid can have a contact angle of above 90 degrees with surface 24. However, typically larger differences in wettability will be desired. For example, the transport liquid can have a contact angle of 0 to 60 degrees or 0 to 45 degrees with surface 24, while the non-transport liquid has a contact angle of greater than 90 degrees, greater than 100 degrees, or greater than 120 degrees up to 180 degrees or up to 170 degrees with surface 24.

Surface 24 can be the surface of the substrate but generally will be a coating on the surface. Thus, in accordance with the above, the transport-surface area, or at least a portion thereof, can be coated with a substance having a higher affinity with—or greater wettability by—the transport liquid than the non-transport liquid. Because of this, the transport liquid selectively flows from the liquid-mixture introduction areas through the transport-liquid track to the transport-liquid receiving area and the non-transport liquid selectively remains in the liquid-mixture introduction area. For example, if transport liquid is an aqueous-based fluid, surface 24 could be a hydrophilic surface/coating, and the non-transport fluid could be an oil or hydrocarbon that is not wettable for surface 24. On the other hand, if the non-transport liquid is an aqueous based fluid, surface 24 could be a hydrophobic surface/coating, and the transport fluid in the liquid mixture would be an oil or hydrocarbon having wettability with surface 24. For example, if surface 24 is hydrophobic, the coating material could be a siloxane.

Generally, the transport liquid and non-transport liquid will be two liquids that are mixed in the sense that they are combined, mixed or blended but will not be significantly dissolvable in one another. Generally, the liquids will be immiscible. For example, the liquid mixture can comprise (1) water or an aqueous fluid and (2) oil or another hydrocarbon with a low solubility in water. Generally, low solubility will be 490 mₛᵥ/mₛᵤ or greater, and can be 5000 mₛᵥ/mₛᵤ, where mₛᵥ is the mass of solvent required to dissolve one unit of mass mₛᵤ of solute.

Liquid-repellant background 14 of device 10 is a liquid-impermeable barrier surrounding the transport-surface area so as to prevent flowing of both the transport liquid and the non-transport liquid from inside the transport-surface area to outside the transport-surface area. Thus, liquid-repellant background 14 at least repels the wetting of the transport liquid and the non-transport liquid, but will typically be an omniphobic substance thus repelling the wetting of all liquids in the droplet mixture, thus limiting liquid transport in the direction defined by the track. For example, the omniphobic substance can be poly(1H,1H,2H,2H heptadecafluorodecyl acrylate). The prevention of wetting outside of transport-surface area 16 and the higher affinity of transport-surface area 16 for the transport liquid than the non-transport liquid in the liquid mixture, results in the selective spreading of the transport liquid (the higher-affinity liquid) and efficient liquid separation on the surface.

This disclosure includes a method for separating and analyzing liquid samples, which may be carried out in some embodiments by the above described device. The method comprising obtaining a liquid mixture having at least one transport liquid and at least one non-transport liquid. A droplet of the liquid mixture is introduced or placed onto an introduction area of the selective liquid-transport surface, wherein the selective liquid-transport area has or is coated with a substance having a higher affinity with the transport liquid than the non-transport liquid such that the transport liquid selectively flows from the liquid-mixture introduction areas through the transport-liquid track to the transport-liquid receiving area and the non-transport liquid remains in the liquid-mixture introduction area.

A sufficient amount of time for the transport liquid to flow across the transport-liquid track and into the receiving area of the selective liquid-transport surface is allowed so that the transport liquid collects in the receiving area. Advantageously, the inventive system and method can carry out the separation in 30 seconds or less, 20 seconds or less, 10 seconds or less, 5 seconds or less. For example, the separation can be carried out in from 1 to 30 seconds, from 1 to 20 seconds, from 1 to 10 seconds, from 1 to 5 seconds; though, typically, the separation will take at least 2 seconds. The term “flow” as used in this disclosure includes flow by capillary or wicking.

Once at least a portion of the transport liquid has collected in the receiving area, the collected transport liquids is analyzed for one or more property and/or the non-transport liquid remaining in the introduction areas is analyzed for one or more property. For example, the transport liquid selectively flowing to the transport-liquid receiving area means that over 50% up to 100% of the transport liquid introduced into the introduction area moves to the receiving areas, and can be at least 75%, at least 80%, at least 90%, at least 95% or at least 99% of the transport-liquid introduced into the introduction area moves into the receiving area. Conversely, the non-transport liquid selectively remaining in the liquid-mixture introduction means over 50% up to 100% of the non-transport liquid introduced into the introduction area remains in the introduction area, and can be at least 75%, at least 80%, or at least 90%, at least 95% or at least 99% of the non-transport liquid introduced into the introduction area remains in the introduction area as the transport liquid moves to the transport-liquid receiving areas. Additionally, the one or more property can be the amount or type of a substance present in the liquid mixture and carried with the transport fluid to the receiving area. For example, one or more property is related to a compound dissolved in the collected transport liquid. For example, the collected transport liquid is analyzed by infrared spectroscopy.

The device and method, as well as the other methods, systems and apparatuses under this disclosure, are fast, disposable, inexpensive ways to prepare a sample which requires separation from a first liquid (non-transport liquid). The sample may be a second liquid (transport liquid) which is in a mixture with the non-transport liquid. Alternatively, the sample may be a substance dissolved, suspended or mixed in the liquid mixture. Generally, if the sample is a separate substance from the transport liquid and the non-transport liquid, it should have a sufficiently different affinity for the transport liquid than the non-transport liquid. For example, it may preferentially dissolve in the transport liquid over the non-transport liquid, or may preferentially suspend or otherwise mix with that transport liquid over the non-transport liquid. Typically, the preferential nature is such that more than 50% of the substance present in the liquid mixture will stay with one liquid when the transport liquid separates from the non-transport liquid. Preferably, at least 75%, 80%, 90%, or 99% of the substance present in the liquid mixture will stay with one liquid when the transport liquid separates from the non-transport liquid. In some embodiments, the sample will initially be mixed with the non-transport fluid prior to forming the blend of the transport fluid and non-transport fluid.

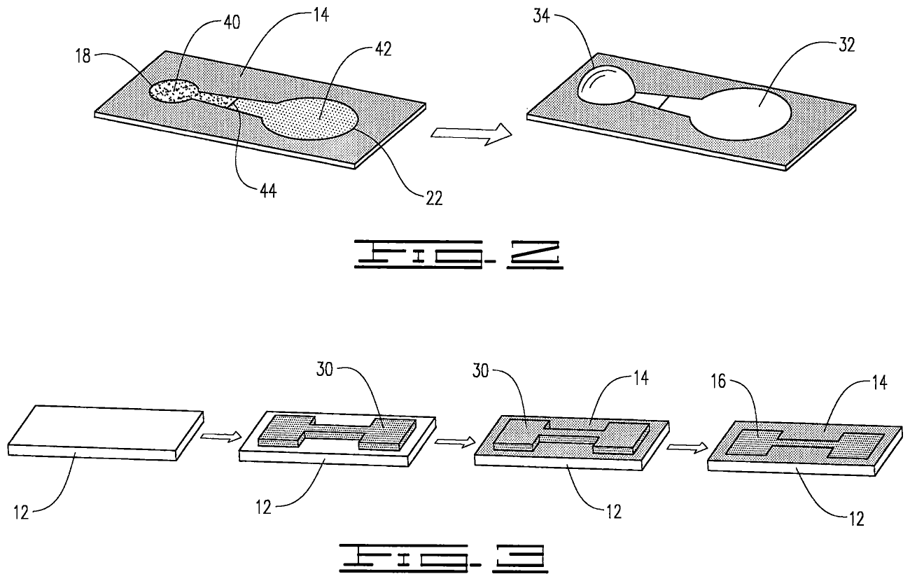

The separation is based on the opposite spreading behaviors of the two liquid phases on the surface. The liquid with a relatively low surface tension spreads, while the other liquid remains stationary. In some embodiments, the transport liquid and non-transport liquid can be separated into two disconnected parts by creating a difference in surface energy. As shown in FIG. 2, the open surface consists of a liquid-repellent background area 14, which ensures any spreading of liquid is along the track, as well as an area having a first surface energy 40 and an area having a second surface energy 42. The first surface-energy area 40 and second surface-energy areas 42 will have different surface energies with one being higher than the other. The different surface energies determine the disconnecting of the two liquids. Accordingly, the difference in surfaces energy should be sufficient to ensure a disconnect of the two liquids. Disconnect herein means at least from 50% to 100% of the transport liquid 32 moves to the receiving areas so as to be separated from the non-transport fluid 34, which remains substantially (over 50%, or at least 75%, at least 89%, at least 90%, at least 95%, or at least 99%) in the liquid-introduction area. More typically, at least 75%, at least 80%, at least 90%, at least 95% or at least 99% of the transport liquid moves to the receiving area. As will be realized by this disclosure, the transport liquid should have a greater affinity for the second surface-energy area 42 than it does for the first surface-energy area 40, and the transport liquid should have a greater affinity for the first surface-energy area 40 than the non-transport liquid does with the first surface-energy area 40.

As illustrated in FIG. 2, the liquid-introduction 18 area and receiving area 22 have circular shapes with diameters of 3.2 mm and 9.5 mm, respectively, and are connected by a wedge-shaped track 20 with a half angle of 3°, length of 10 mm, and initial width of 2 mm. The liquid-introduction area 18 and a part of its connected track 20 have a surface energy of γ1, the receiving area 22 and a part of its connected track have a surface energy of γ2, and γ1<γ2. As illustrated, the boundary of surface energy change 44 lies in the midpoint of the track, but it may also lie closer to the liquid introduction area 18, for example in the range of 2-10 mm from the starting point of the track.

The disclosure further encompasses a method for producing a selective liquid-transport device having at least one transport-surface area comprising an introduction area, a transport-liquid track, and a transport-liquid receiving area as described above. The method comprises selecting a contiguous geometric shape for the transport-surface area such that the introduction area is in fluid flow communication with the transport-liquid track, and the transport-liquid track is in fluid flow communication with the transport-liquid receiving area.

Based on the selection, a stamp is prepared in the geometric shape of the transport-surface area wherein the stamp includes a substance having a higher affinity with a transport liquid than a non-transport liquid. As shown in FIG. 3, a substrate 12 is selected and the stamp 30 is placed in contact with a substrate such that at least a portion of the substance is transferred to the substrate to produce a coating on the substrate in the geometric shape of the stamp. Generally, the amount of substance transferred should be enough to establish the affinities, wetting properties and/or surface energy properties as discussed herein.

For example, in the method the stamp can be formed from polydimethylsiloxane (PDMS) and results in the absorption of siloxane molecules by the substrate. For example, SYLGARD® 184 kit, marketed by Dow or an affiliated company of Dow can be used to produce the stamp. SYLGARD® 184 is a silicone based elastomeric kit that is a two-component system with a polymeric base and a curing agent which cross-links with the polymeric matrix. The resulting composite formed is a polydimethylsiloxane (PDMS) with tensile strength (UTS) of ˜5.2 MPa and shore hardness of ˜44 at room temperature.

As will be realized the coating is applied to the area covered by the stamp to thus coat the substrate in the geometrical shape of stamp. In such embodiments, the coating material is a siloxane, which is a hydrophobic material.

The contact of the stamp with the substrate should be a tight contact. That is, the stamp should be sufficiently in contact with the substrate to prevent fluid around the edges of the stamp from seeping into the space covered by the stamp. More specifically, the contact needs to be sufficient to prevent the liquid-repellant coating added to the background in a subsequent step from seeping into the space covered by the stamp.

The method also includes a step of creating a liquid-repellant background surface 14 on the substrate surface such that the liquid-repellant background surrounds the stamp 30, and hence will surround the transport-surface area. The liquid-repellant background 14 is a liquid-impermeable barrier so as to prevent flowing of both the transport liquid and the non-transport liquid from inside the transport-surface area to outside the transport-surface area. Generally, the liquid-repellant coating the background area will have a thickness of about 100 nm to about 500 nm. Subsequently, stamp 30 can be removed from the substrate so as to expose the transport-surface area 16.

For example, the background area can be coated with an omniphobic substance as previously discussed. In some embodiments the background coating onto the substrate surface is by vapor deposition.

For example, the vapor deposition can occur by a method comprising introducing the substrate into a chemical vapor deposition reactor. Generally, the stamp will be in place on the substrate prior to introduction into the chemical vapor deposition reactor. Next, the pressure in the chemical vapor deposition reactor reduced from atmospheric to a first predetermined pressure. For example, the first predetermined pressure can be 0.05 Torr or less.

After reduction in pressure the omniphobic substance or precursors that will form the omniphobic substance are vaporized. For example, if the omniphobic substance is poly(1H,1H,2H,2H heptadecafluorodecyl acrylate), then monomeric 1H,1H,2H,2H-heptadecafluorodecyl acrylate and tert-butyl peroxide can be vaporized. In this case, the monomeric 1H,1H,2H,2H-heptadecafluorodecyl acrylate can be vaporized at a first temperature, and the tert-butyl peroxide can be vaporized at a second temperature. For example, the first temperature can be from about 75° C. to about 90° C., and the second temperature can be from about 20° C. to about 30° C., for the predetermined pressure in the range. For example, at 0.01 Torr the first temperature can be about 80° C. and the second temperature can be about 25° C.

Once vaporized, the 1H,1H,2H,2H-heptadecafluorodecyl acrylate and tert-butyl peroxide are injected into the reactor at a first flow rate and a second flow rate, respectively. For example, the first flow rate can be from about 0.3 sccm to about 0.5 sccm, and the second flow rate can be from about 0.5 sccm to about 0.1 sccm.

Upon injection the pressure within the reactor can be controlled at a second predetermined pressure. Generally, this second predetermined temperature will be higher than the first predetermined pressure but below atmospheric pressure. For example, the second predetermined pressure can be from about 0.15 Torr to about 0.35 Torr. Additionally, the chemical vapor deposition reactor is heated to an elevated temperature above the first temperature. For example, the elevated temperature can be from about 180° C. to about 280° C.

During this period of heating, the substrate is cooled and maintained at a cooled temperature below the elevated temperature such that a polymer film deposits on the substrate from the vaporized 1H,1H,2H,2H-heptadecafluorodecyl acrylate and tert-butyl peroxide. For example, the cooled temperature can be below 180° C., but generally will be less than 100° C., less than 75° C., and more typically will be about 20° C. to about 40° C.

Also, during this period the thickness of the deposited polymer film is generally monitored to determine if a desired or predetermined thickness for the polymer film has been reached. For example, the predetermined thickness can be about 100 nm to about 500 nm. Once the polymer has reached the predetermined thickness, the initiated chemical vapor deposition process is stopped.

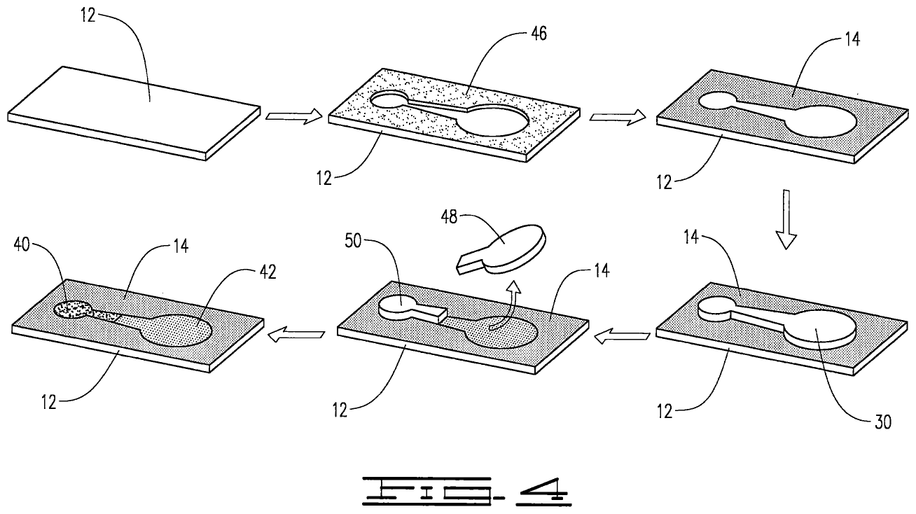

In an alternative embodiment for producing a selective liquid-transport device involves creating different surface energies in the liquid-transport surface area. As illustrated in FIG. 4, a pre-designed kirigami 46 is placed on the substrate surface 12, followed by wetting the kirigami with an omniphobic coating so as to deposit the omniphobic coating and produce background 14, which defines the liquid-transport surface area 16. The kirigami may be removed after the coating dries. For example, the kirigami can be fabricated by cutting a microporous paper into the desired dimensions for the liquid-transport surface areas.

Next, the stamp 30 (as described above) can be placed on the oleophobic coating-free area. Part 48 of the stamp 30 is removed, while the other part 50 remains in contact for a longer period time. At the last step, the remaining stamp portion 50 is removed. In the case illustrated, part 48 has a shorter contact time and part 50 has a longer contact time. The longer contact time of the stamp results in more adsorption of a substance which is selected to result in a lower surface energy. As will be realized, the longer contact time will be greater than the shorter contact time. The shorter contact time can have a minimum contact time that is essentially zero. The longer contact time should be sufficient to make a change in the surface energy for its associated surface area from the area of shorter contact time so as to facilitate the disconnect of the transport fluid from the non-transport fluid. This results in inhibited movement of the non-transport fluid because the transport fluid can preferentially occupy the air-solid interface of the track, as the affinity between the transport fluid and the track is greater than the affinity between the non-transport fluid and the track. For example, for some substances deposited by the stamp, the longer contact time can be greater than 60 minutes to about 240 minutes, and the shorter contact time being 60 minutes or less.

### EXAMPLES

### Example 1

The selective liquid transport surfaces were fabricated using the process described above. First, a microcontact polydimethylsiloxane (PDMS) stamp was placed in tight contact with the substrate, which resulted in adsorption of siloxane molecules onto the stamped region and provides the proper surface wettability for the spreading of low-surface-tension liquids. Subsequently, an omniphobic coating that resists the wetting of all liquids was deposited to provide the background surface. At the last step, the stamp was removed, exposing the mixing area for the dispense of droplet mixture, the track for the selective liquid transport, and the receiving area for the selected liquid.

The PDMS stamps used were produced from commercial Sylgard® 184 following the steps of:
mixing the base and the curing agent in a weight ratio of 10:1;
degassing of the mixture for 15 min;
curing the mixture at a temperature of 60° C. for 30 min; and
cutting the cured PDMS into the dimensions listed in Table 1.

TABLE 1
Dimensions of the fabricated liquid transport surfaces

| | l | w | lₘ | lᵣ |
|---|---|---|---|---|
| | (mm) | (mm) | (mm) | (mm) |
| Surface A | 20 | 0.8 | 0 | 0 |
| Surface B | 20 | 1.2 | 0 | 0 |
| Surface C | 20 | 1.6 | 0 | 0 |
| Surface D | 20 | 2.0 | 5 | 5 |
| Surface E | 4 | 2.0 | 5 | 7 |

Silicon wafers substrates covered with the PDMS stamps were coated with poly(1H,1H,2H,2H-heptadecafluorodecyl acrylate) (PHDFA) by an initiated vapor deposition (iCVD) process following the steps of:
vacuuming the iCVD reactor to 0.01 torr or less;
vaporizing the monomer, 1H,1H,2H,2H-heptadecafluorodecyl acrylate (HDFA), and the initiator tert-butyl peroxide (TBP) at 80° C. and 25° C., respectively;
injecting the vaporized HIDFA and TBP into the reactor at a flow rate of 0.4 sccm and 0.1 sccm, respectively;
controlling the pressure within the reactor at 0.15 Torr;
heating the filament of the iCVD reactor to maintain a temperature at 200° C.;
cooling the substrate of the iCVD reactor to maintain a temperature at 40° C.;
monitoring the thickness of the deposited polymer films;
stopping the iCVD process when the deposited polymer reached a thickness of about 100-500 nm.

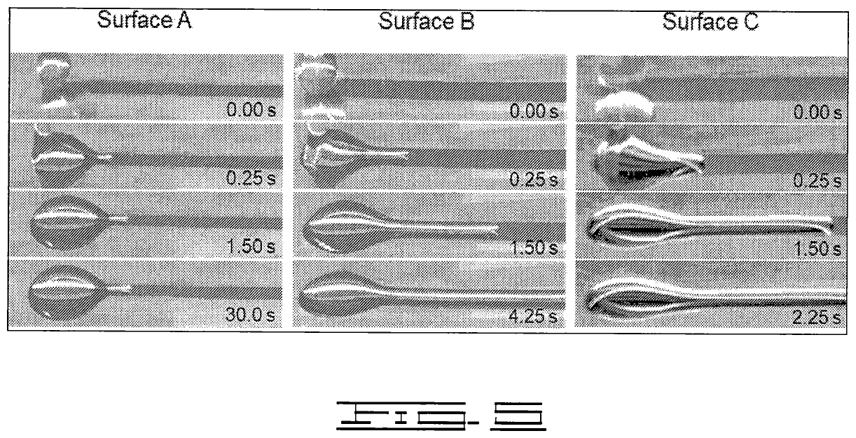

The tracks formed on surface A, B, and C were tested for the transport of a 10-μL decane droplet. FIG. 5 shows the snapshots of droplet transport dynamics on tracks. The decane droplet remained almost stationary on the 0.8-mm-wide track of surface A, but spontaneously flowed through the 1.2-mm-wide track on surface B. As the track width increased to 1.6 mm on surface C, the flow rate of the decane droplet further increased that it transported through the entire track in 2.25 s. The results indicate that track width is a critical factor determining the rate of the spontaneous liquid transport.

FIG. 6 demonstrates the separation of decane from water on surface D. Decane and water (dyed with Alizarin Red) were mixed at the volume ratio of 1:1 and sonicated to form an emulsion. After a 20-μL droplet of the decane/water mixture was dispersed to the mixing area, decane was observed to spontaneously flow out of the mixture down the track. The rapid separation of decane from the mixture droplet was attributed to the strong hydrophobic attractive interaction between decane and the track surface. This interaction drove the spontaneous movement of decane on the track. In contrast, the dyed water remained stationary within the mixing area, because water cannot spread onto the hydrophobic track surface.

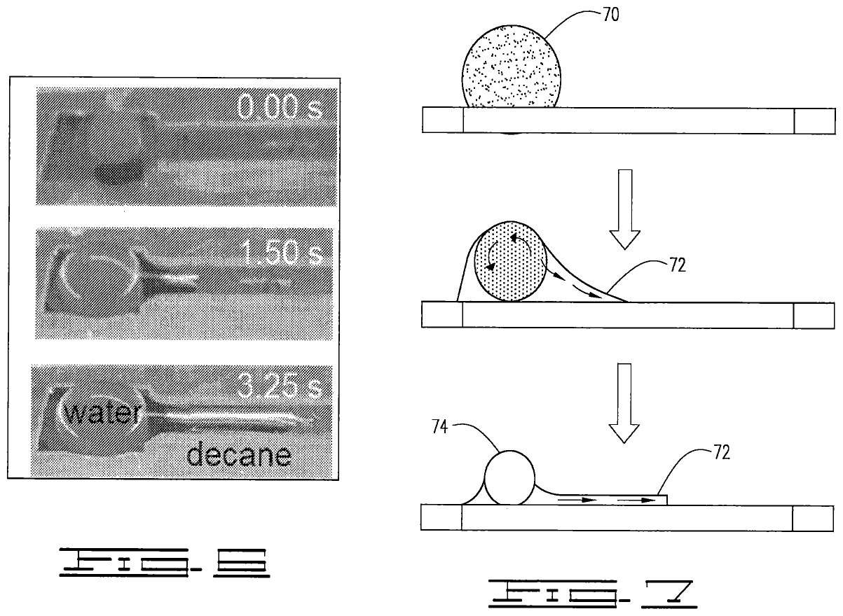

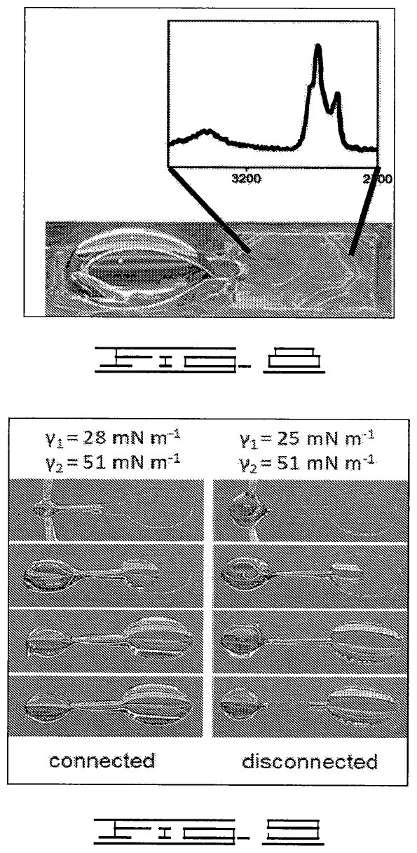

The separation and analysis of cholesterol was demonstrated using the selective liquid transport on surface E. In the mixing area, 80 μL of cholesterol aqueous solution at 5 mg/L was mixed with 80 μL of hexane to form mixed droplet 70. Because of the higher solubility of cholesterol in hexane, hexane extracted cholesterol 72 from the aqueous solution 74 and flowed through the separation track, resulting in the collection of cholesterol in the receiving area, as illustrated in FIG. 7. The collected cholesterol was analyzed using infra-red spectroscopy, and the characteristic absorption peaks were shown in FIG. 8.

### Example 2

The microdroplet separation surface with a combination of different surface energies was fabricated using the process illustrated in FIG. 4. First, an omniphobic coating was deposited on the substrate in a patterned manner. This was achieved by placing a pre-designed kirigami on the silicon wafer surface, followed by wetting the kirigami with 3M Scotchgard solutions at 6-10 μL/cm² to ensure full wetting of the kirigami but no overflow of the solution into the transport area. The kirigami was removed after the solution dried. The kirigami was fabricated by cutting a microporous paper into the dimensions described in relation to FIG. 4. Second, a microcontact PDMS stamp was placed on the oleophobic coating-free area at contact time ranging from 0 min to 240 min. The fabrication process of the PDMS stamp follows the steps described in Example 1. Third, a part of the PDMS stamp was removed, while the other remained in contact for a longer period time. At the last step, the remaining stamp was removed. Longer contact time of the stamp resulted in more adsorption of siloxane molecules on the surface, thus lower surface energy.

Table 2 shows the decrease of surface energy with the increase of PDMS stamp contact time. Increasing the contact time from 0 min to 240 min led to the surface energy reduction from 55 mN m⁻¹ to 22 mN m⁻¹. The 240-min modified surface showed a decane and water contact angle of 11.4° C. and 106.8° C., respectively. Surfaces with both oleophilicity and hydrophobicity facilitate the separation of oil from water in the mixing area.

TABLE 2

| | contact time (min) | | | | | | |
|---|---|---|---|---|---|---|---|
| | 0 | 1 | 30 | 60 | 90 | 120 | 240 |
| surface energy | 55 | 51 | 43 | 36 | 28 | 25 | 22 |
| (mN m⁻¹) | | | | | | | |
| relative standard | 0.5 | 0.3 | 5.5 | 2.8 | 3.9 | 3.2 | 3.9 |
| deviation (%) | | | | | | | |

FIG. 9 demonstrates the separation of decane and water on surfaces with different combinations of γ₁ and γ₂. The initial mixture contains 20 μL water and 20 μL decane. The dimensions of the track, starting area, and receiving area are described in relation to FIG. 2. For the surface with γ₁/γ₂=28/51 mN m⁻¹, the separated decane was connected with the mixture after separation. For the surface with γ₁/γ₂=25/51 mN m⁻¹, decane was disconnected from the mixture after separation, owing to the receding of the decane driven by the larger surface energy differences. In principle, surfaces having a sufficiently large surface energy difference can achieve such “disconnected” separations.

Table 3 illustrates separation status for the surfaces with different combinations of surface energy. The dimensions of the track, starting area, and receiving area are described in FIG. 2. “d” and “c” denote the “disconnected” and “connected” status, respectively. As shown in Table 3, with γ₂=51 mN m⁻¹, the surface achieved “disconnected” separations when γ₁≤25 mN m⁻¹. With γ₂=55 mN m⁻¹, the surfaces can achieve “disconnected” separations when γ₁≤43 mN m⁻¹

TABLE 3

γ₁ (mN m⁻¹)

| | 55 | 51 | 43 | 36 | 28 | 25 | 22 |
|---|---|---|---|---|---|---|---|
| γ₂ = 55 mN m⁻¹ | c | c | d | d | d | d | d |
| γ₂ = 51 mN m⁻¹ | c | c | c | c | c | d | d |
| γ₂ = 43 mN m⁻¹ | c | c | c | c | c | c | c |

Embodiments of the invention can be further understood by referenced to the following numbered paragraphs.

1. A selective liquid-transport device for separating a liquid mixture having at least one transport liquid and at least one non-transport liquid, the selective liquid-transport device comprising:
a substrate;
a liquid repellant background surface on the substrate; and
at least one transport-surface area defined by the liquid-repellant background, wherein the transport-surface area has a liquid-mixture introduction area, a transport-liquid track, and a transport-liquid receiving area; and
wherein the liquid-repellant background is a liquid-impermeable barrier surrounding the transport-surface area so as to prevent flowing of both the transport liquid and the non-transport liquid from inside the transport-surface area to outside the transport-surface area; and
wherein the transport-surface area is coated with a substance such that the liquid-mixture introduction area and at least a portion of the transport-liquid track adjacent to the liquid-mixture introduction area have a higher affinity with the transport liquid than the non-transport liquid such that the transport liquid selectively flows from the liquid-mixture introduction area through the transport-liquid track to the transport-liquid receiving area and the non-transport liquid selectively remains in the liquid-mixture introduction area.

2. The selective liquid-transport device of paragraph 1, wherein the transport surface is coated with a hydrophilic material.

3. The selective liquid-transport device of paragraph 1, wherein the transport surface is coated with a hydrophobic material.

4. The selective liquid-transport device of paragraph 3, wherein the hydrophobic material is a siloxane.

5. The selective liquid-transport device of any preceding paragraph, wherein the liquid-repellant background is coated with an omniphobic substance.

6. The selective liquid-transport device of paragraph 5, wherein the omniphobic substance is poly(1H,1H,2H,2H heptadecafluorodecyl acrylate).

7. A method for separating and analyzing liquid samples, the method comprising:
obtaining a liquid mixture having at least one transport liquid and at least one non transport liquid;
placing a droplet of the liquid mixture onto an introduction area of a selective liquid-transport surface, wherein the selective liquid-transport area has the introduction area, a transport-liquid track and a receiving areas, and wherein the selective liquid-transport area is coated with a substance having a higher affinity with the transport liquid than the non-transport liquid such that the transport liquid selectively flows from the liquid-mixture introduction areas through the transport-liquid track to the transport-liquid receiving area and the non-transport liquid selectively remains in the liquid-mixture introduction area;
allowing a sufficient amount of time for the transport liquid to flow across the transport-liquid track and into the receiving area of the selective liquid-transport surface so that the transport liquid collects in the receiving area;
subsequent to the step of allowing sufficient amount of time, analyzing at least one of (i) the transport liquid collected in the receiving area, and (ii) the non-transport liquid in the introduction areas for one or more property.

8. The method of paragraph 7, wherein the transport-surface area is defined on a substrate by a liquid-repellant background surrounding the transport-surface area, and wherein the liquid-repellant background is a liquid-impermeable barrier so as to prevent flowing of both the transport liquid and the non-transport liquid from inside the transport-surface area to outside the transport-surface area.

9. The method of either paragraph 7 or 8, wherein the collected transport liquid or non-transport liquid is analyzed by infrared spectroscopy.

10. The method of any of paragraphs 7 to 9, wherein the one or more property is related to a compound dissolved in the collected transport liquid.

11. The method of any of paragraphs 7 to 10, wherein the transport surface is coated with a hydrophilic material.

12. The method of any of paragraphs 7 to 10, wherein the transport surface is coated with a hydrophobic material.

13. The method of paragraph 12, wherein the hydrophobic material is a siloxane.

14. The method of any of paragraphs 7 to 13, wherein the liquid-repellant background is coated with an omniphobic substance.

15. The method of paragraph 14, wherein the omniphobic substance is poly(1H,1H,2H,2H heptadecafluorodecyl acrylate).

16. A method for producing a selective liquid-transport device having at least one transport-surface area comprising an introduction area, a transport-liquid track, and a transport-liquid receiving area, the method comprising:
selecting a contiguous geometric shape for the transport-surface area such that the introduction area is in fluid flow communication with the transport-liquid track, and the transport-liquid track is in fluid flow communication with the transport-liquid receiving area;
preparing a stamp in the geometric shape of the transport-surface area wherein the stamp includes a substance having a higher affinity with a transport liquid than a non-transport liquid;
placing the stamp in contact with a substrate such that at least a portion of the substance is transferred to the substrate to produce a coating on the substrate in the geometric shape of the stamp;
creating a liquid repellant background area on the substrate surface such that the liquid-repellant background surrounds the transport-surface area, and wherein the liquid-repellant background is a liquid-impermeable barrier so as to prevent flowing of both the transport liquid and the non-transport liquid from inside the transport-surface area to outside the transport-surface area; and
removing the stamp from the substrate.

17. The method of paragraph 16, wherein the substance is a hydrophilic material.

18. The method of paragraph 16, wherein the substance is a hydrophobic material.

19. The method of paragraph 18, wherein the hydrophobic material is a siloxane.

20. The method of paragraph 19, wherein the stamp is formed from polydimethylsiloxane (PDMS) and results in the absorption of siloxane molecules by the substrate.

21. The method of any of paragraphs 16 to 20, wherein the liquid-repellant background is coated with an omniphobic substance.

22. The method of paragraph 21, wherein the omniphobic substance is deposited onto the substrate surface by vapor deposition.

23. The method of paragraph 22, wherein the omniphobic substance is poly(1H,1H,2H,2H heptadecafluorodecyl acrylate).

24. The method of paragraph 24, wherein the vapor deposition occurs by a method comprising:
introducing the substrate into a chemical vapor deposition reactor;
reducing pressure in the chemical vapor deposition reactor from atmospheric to a first predetermined pressure;
vaporizing a monomeric 1H,1H,2H,2H-heptadecafluorodecyl acrylate and a tert-butyl peroxide at a first temperature and a second temperature, respectively;
injecting the vaporized 1H,1H,2H,2H-heptadecafluorodecyl acrylate and tert butyl peroxide into the reactor at a first flow rate and a second flow rate, respectively;
controlling the pressure within the reactor at a second predetermined pressure;
heating the chemical vapor deposition reactor to an elevated temperature above the first temperature;
cooling the substrate to maintain a cooled temperature below the elevated temperature such that a polymer film deposits on the substrate from the vaporized 1H,1H,2H,2H-heptadecafluorodecyl acrylate and tert butyl peroxide;
monitoring the thickness of the deposited polymer film; and
stopping the initiated chemical vapor deposition process when the deposited polymer reaches a predetermined thickness.

25. The method of paragraph 24, wherein:
the first predetermined pressure is 0.05 Torr or less;
the first temperature is from about 75° C. to about 90° C.;
the second temperature is from about 20° C. to about 30° C.;
the first flow rate is from about 0.3 sccm to about 0.5 sccm;
the second flow rate is from about 0.5 sccm to about 0.2 sccm;
the second predetermined pressure is from about 0.15 Torr to about 0.35 Torr;
the elevated temperature is from about 180° C. to about 280° C.;
the cooled temperature is about 20° C. to about 40° C.; and
the predetermined thickness is about 100 nm to about 500 nm.

26. The method of any of paragraphs 16 to 25, wherein the substrate is comprised of at least one of silicon, glass, metal, plastic, or paper.

Therefore, the present compositions and methods are well adapted to attain the ends and advantages mentioned, as well as those inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1. A selective liquid-transport device for separating a liquid mixture having at least one transport liquid and at least one non-transport liquid, the selective liquid-transport device comprising:
a substrate;
a liquid-repellant background surface on the substrate; and
at least one transport-surface area defined by the liquid-repellant background, wherein the transport-surface area has a liquid-mixture introduction area, a transport-liquid track, and a transport-liquid receiving area; and
wherein the liquid-repellant background is a liquid-impermeable barrier surrounding the transport-surface area so as to prevent flowing of both the transport liquid and the non-transport liquid from inside the transport-surface area to outside the transport-surface area; and
wherein the transport-surface area is coated with a substance such that the liquid-mixture introduction area and at least a portion of the transport-liquid track adjacent to the liquid-mixture introduction area have a higher affinity with the transport liquid than the non-transport liquid such that the transport liquid selectively flows from the liquid-mixture introduction area through the transport-liquid track to the transport-liquid receiving area and the non-transport liquid selectively remains in the liquid-mixture introduction area.

2. The selective liquid-transport device of claim 1, wherein the transport surface is coated with a hydrophilic material.

3. The selective liquid-transport device of claim 1, wherein the transport surface is coated with a hydrophobic material.

4. The selective liquid-transport device of claim 3, wherein the hydrophobic material is a siloxane.

5. The selective liquid-transport device of claim 1, wherein the liquid-repellant background is coated with an omniphobic substance.

6. The selective liquid-transport device of claim 5, wherein the omniphobic substance is poly(1H,1H,2H,2H-heptadecafluorodecyl acrylate).

7. A method for separating and analyzing liquid samples, the method comprising:
obtaining a liquid mixture having at least one transport liquid and at least one non-transport liquid;
placing a droplet of the liquid mixture onto an introduction area of a transport-surface area, wherein the transport-surface area has the introduction area, a transport-liquid track and a receiving area, and wherein the transport-surface area is coated with a substance having a higher affinity with the transport liquid than the non-transport liquid such that the transport liquid selectively flows from the introduction area through the transport-liquid track to the receiving area and the non-transport liquid selectively remains in the introduction area;
allowing a sufficient amount of time for the transport liquid to flow across the transport-liquid track and into the receiving area of the selective liquid-transport surface so that the transport liquid collects in the receiving area; and
subsequent to the step of allowing sufficient amount of time, analyzing at least one of (i) the transport liquid collected in the receiving area, and (ii) the non-transport liquid in the introduction area for one or more property.

8. The method of claim 7, wherein the transport-surface area is defined on a substrate by a liquid-repellant background surrounding the transport-surface area, and wherein the liquid-repellant background is a liquid-impermeable barrier so as to prevent flowing of both the transport liquid and the non-transport liquid from inside the transport-surface area to outside the transport-surface area.

9. The method of claim 8, wherein the collected transport liquid or non-transport liquid is analyzed by infrared spectroscopy.

10. The method of claim 8, wherein the one or more property is related to a compound dissolved in the collected transport liquid.

11. The method of any of claim 8, wherein the transport surface is coated with a hydrophilic material.

12. The method of claim 8, wherein the transport surface is coated with a hydrophobic material.

13. The method of claim 12, wherein the hydrophobic material is a siloxane.

14. The method of claim 8, wherein the liquid-repellant background is coated with an omniphobic substance.

15. The method of claim 14, wherein the omniphobic substance is poly(1H,1H,2H,2H-heptadecafluorodecyl acrylate).

16. A method for producing a selective liquid-transport device having at least one transport-surface area comprising an introduction area, a transport-liquid track, and a transport-liquid receiving area, the method comprising:
selecting a contiguous geometric shape for the transport-surface area such that the introduction area is in fluid flow communication with the transport-liquid track, and the transport-liquid track is in fluid flow communication with the transport-liquid receiving area;
preparing a stamp in the geometric shape of the transport-surface area wherein the stamp includes a substance having a higher affinity with a transport liquid than a non-transport liquid;
placing the stamp in contact with a substrate such that at least a portion of the substance is transferred to the substrate to produce a coating on the substrate in the geometric shape of the stamp;
creating a liquid-repellant background area on the substrate surface such that the liquid-repellant background surrounds the transport-surface area, and wherein the liquid-repellant background is a liquid-impermeable barrier so as to prevent flowing of both the transport liquid and the non-transport liquid from inside the transport-surface area to outside the transport-surface area; and
removing the stamp from the substrate.

17-20. (canceled)

21. The method of claim 16, wherein the liquid-repellant background is coated with an omniphobic substance.

22. The method of claim 21, wherein the omniphobic substance is deposited onto the substrate surface by vapor deposition.

23. The method of claim 22, wherein the omniphobic substance is poly(1H,1H,2H,2H-heptadecafluorodecyl acrylate).

24. The method of claim 23, wherein the vapor deposition occurs by a method comprising:
introducing the substrate into a chemical vapor deposition reactor;
reducing pressure in the chemical vapor deposition reactor from atmospheric to a first predetermined pressure;
vaporizing a monomeric 1H,1H,2H,2H-heptadecafluorodecyl acrylate and a tert-butyl peroxide at a first temperature and a second temperature, respectively;
injecting the vaporized 1H,1H,2H,2H-heptadecafluorodecyl acrylate and tert-butyl peroxide into the reactor at a first flow rate and a second flow rate, respectively;
controlling the pressure within the reactor at a second predetermined pressure;
heating the chemical vapor deposition reactor to an elevated temperature above the first temperature;
cooling the substrate to maintain a cooled temperature below the elevated temperature such that a polymer film deposits on the substrate from the vaporized 1H,1H,2H,2H-heptadecafluorodecyl acrylate and tert-butyl peroxide;
monitoring the thickness of the deposited polymer film; and
stopping the initiated chemical vapor deposition process when the deposited polymer reaches a predetermined thickness.

25-26. (canceled)
